(19) United States
(12) Patent Application Publication
(10) Pub. No.: US 2006/0259301 A1
(43) Pub. Date: Nov. 16, 2006

(54) High quality thai text-to-phoneme converter

(75) Inventors: Ding Guohong, Beijing (CN); Wang Xia, Beijing (CN); Cao Yang, Beijing (CN); Ding Feng, Beijing (CN); Tang Yuezhong, Beijing (CN)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/127,707

(22) Filed: May 12, 2005

(51) Int. Cl. G10L 15/26

(52) U.S. Cl. 704/235

(57) ABSTRACT

An improved, high-quality Thai text-to-phoneme converter. Syllabification is performed strictly according to the Thai pronunciation rules. Initial vowels, Thai syllable structures, special vowels, leading vowels, syllables with silent marks, unterminated vowels and terminated vowels are used to accurately implement the Thai syllabification. After syllabification, the most probable phonemes are obtained for all of the syllables using a rule-based approach in one embodiment of the invention.

### FIELD OF THE INVENTION

The present invention relates generally to text-to-phoneme converters. More particularly, the present invention relates to text-to-phoneme converters for use with the Thai language.

### BACKGROUND OF THE INVENTION

A text-to-phoneme (TTP) converter is a routine that converts a word sequence into the sequence's corresponding phonetic transcription. This process is one of the essential routines in developing and implementing speech recognition and speech synthesis systems. In these systems, the basic units are usually phonemes. The conversion of texts to phonemes is an important role and has a great effect on the performance in both of these speech processing systems.

In Thai TTP processing, there are currently two types of approaches. These approaches are a rule-based approach and a decision-tree-based approach.

Although moderately useful, neither the rule-based approach or the decision-tree-based approach achieves a desirable level of TTP performance. The rule-based approach has a drawback in the limitation of employing the context for making a decision. Although the decision-tree based approach is capable of capturing the local context for making the decision, the pronunciation rule of Thai is too complicated for this approach, hindering its performance.

It is conventionally believed that the accuracy of both of the above Thai TTP approaches is no more than about 70%. Such a low accuracy rate may significantly constrain the performance of speech recognition and speech synthesis systems. It is therefore desirable to develop a more accurate TTP approach for use in Thai speech recognition and speech synthesis systems.

### SUMMARY OF THE INVENTION

The present invention provides for a high-quality Thai TTP converter. In the present invention, syllabification is performed strictly according to the Thai pronunciation rules. Initial vowels, Thai syllable structures, special vowels, leading vowels, syllables with silent marks, unterminated vowels and terminated vowels are used to accurately implement the Thai syllabification. In syllabification, tone marks are treated as vowels or as part of vowels. The tone marks make the syllabification more accurate because it is always in the position of vowels, and the obtained phonemes are more accurate than in conventional systems. After syllabification, the most probable phonemes are obtained for all of the syllables using a rule-based approach in one embodiment of the invention since, after syllabification, the TTP is simple and direct.

With the present invention the accuracy of the obtained phoneme transcription is greatly improved over conventional systems. This improved accuracy results in a higher performance for the Thai speech recognition and synthesis system.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a perspective view of a mobile telephone that can be used in the implementation of the present invention;

FIG. 2 is a schematic representation of the telephone circuitry of the mobile telephone of FIG. 1; and

FIG. 3 is a flow chart showing the steps involved in one implementation of the present invention.

### DETAILED DESCRIPTION OF THE PREFERRED EMBODIMENTS

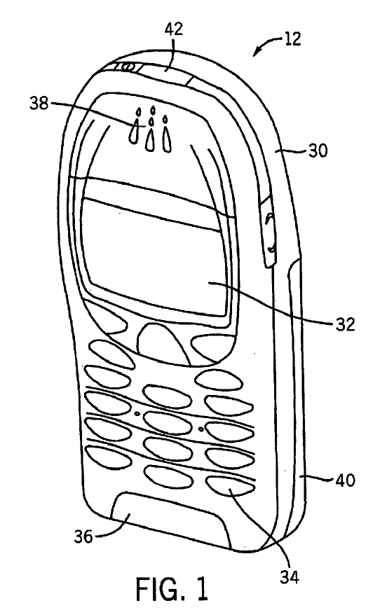

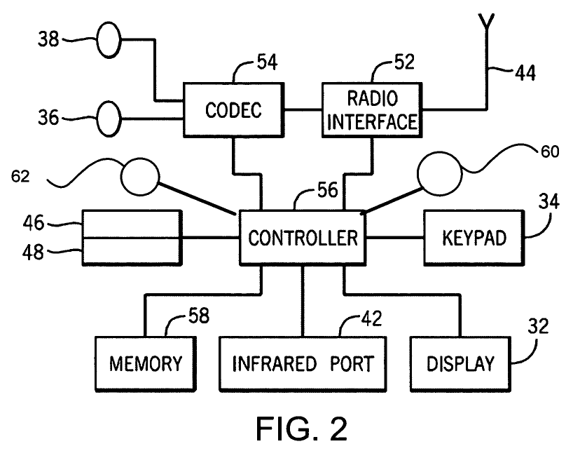

FIGS. 1 and 2 show one representative mobile telephone 12 within which the present invention may be implemented. It should be understood, however, that the present invention is not intended to be limited to one particular type of mobile telephone 12 or other electronic device. For example, exemplary devices may include, but are not limited to, a mobile telephone 12, a combination PDA and mobile telephone, a PDA, an integrated messaging device (IMD), a desktop computer, and a notebook computer. The devices may be stationary or mobile as when carried by an individual who is moving. The devices may also be located in a mode of transportation including, but not limited to, an automobile, a truck, a taxi, a bus, a boat, an airplane, a bicycle, a motorcycle, etc.

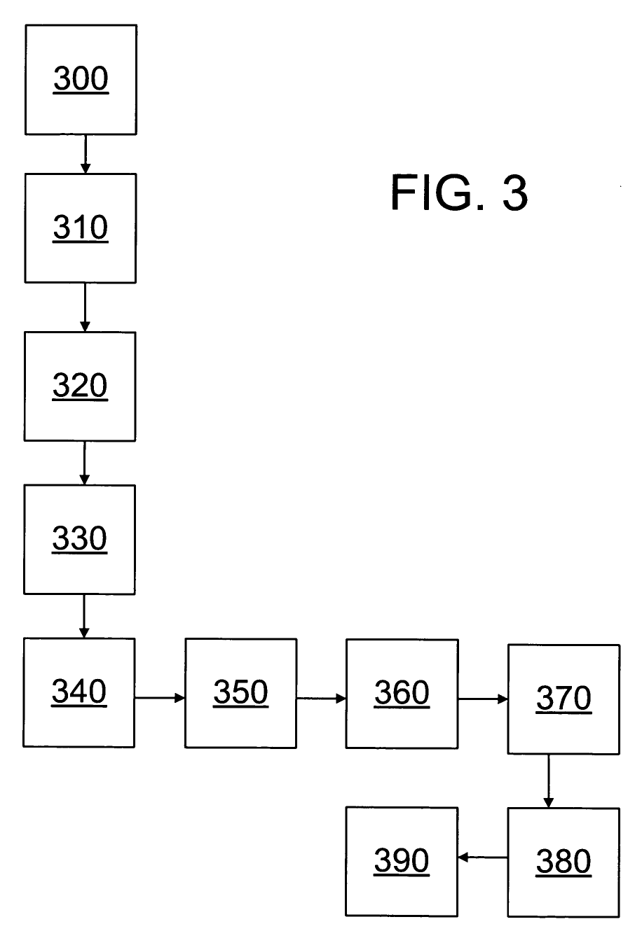

The mobile telephone 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Such a device may also contain a speaker 60 for the pronunciation of words and a microphone 62 for receiving spoken word information from a user. Individual circuits and elements are all of a type well known in the art, for example in the Nokia range of mobile telephones.

The present invention provides for an improved, high-quality Thai text-to-phoneme converter. In the present invention, syllabification is performed strictly according to the Thai pronunciation rules. Initial vowels, Thai syllable structures, special vowels, leading vowels, syllables with silent marks, unterminated vowels and terminated vowels are used to accurately implement the Thai syllabification. In syllabification, tone marks are treated as vowels or as part of vowels. The tone marks make the syllabification more accurate since it is always in the position of vowels and the obtained phonemes are more accurate than in conventional systems. After syllabification, the most probable phonemes are obtained for all of the syllables using a rule-based approach in one embodiment of the invention.

Thai has very complicated pronunciation phenomena. These phenomena are discussed in detail below. Aiming at the complicated phenomena, the TTP approach of the present invention syllabifies Thai words strictly according to Thai pronunciation rule and then mapping of syllables to phoneme transcription is performed using the rule-based approach.

It is difficult to construct a perfect Thai text-to-phoneme converter because there are many non-standard pronunciation phenomena in Thai. These difficulties include the issues identified below.

Initial vowels: In Thai, there are five initial vowels, e.g., [symbol] and [symbol] which are inverted after the initial consonants during pronunciation. Therefore, it is necessary in Thai TTP to invert initial vowels to their corresponding pronunciation position. However, initial consonants may be single-letter consonants or double-letter consonants. When the consonant after an initial vowel is a double-letter consonant, the issue may be quite complicated, since a double-letter consonant can be split to be taken as two consonants, and the initial vowel can be placed after the single-letter consonant, or after the double-letter consonant. For example, [symbol] is an initial double-letter consonant. [symbol] is pronounced as /k-r-e:-N/, where [symbol] is taken as an initial consonant and [symbol] is placed after [symbol] during pronunciation. However, in [symbol] which is pronounced as /k-e:-r-a-n-u-t/, [symbol] is placed just after [symbol] in pronunciation.

Implicit pronunciation of some vowels without having any written forms: In Thai, abbreviatory written forms are common, particularly for vowels. For example, in [symbol] which is pronounced as /k-a-m-o-n-m-a:-t/, [symbol] is taken as a separate syllable and [symbol] is taken as another syllable. In this case, [symbol] is pronounced as /k-a/, which shows that the vowel “a” is omitted and [symbol] also possesses an implicit vowel /o/ in pronunciation. In other words, if a letter is considered as a separate syllable, then the vowel “a” should be complemented. Additionally, if two consonants are combined to comprise a syllable, then the vowel ‘o’ should be placed between the letters. These two cases are quite common in Thai, and the problem can only be processed in a satisfactory manner with an accurate syllabification.

A consonant is shared by two syllables: Final consonants may be propagated to be initial consonants of a number of syllables. For example, [symbol] is pronounced as /s?-u-b-a-t-t-i-h-e:-t/, where [symbol] is composed of two syllables, [symbol] and [symbol] which are pronounced as /b-a-t/ and /t-i/, respectively. The letter [symbol] the final consonant of the first syllable, is propagated to be the initial consonant of the second syllable. In Thai, however, the cases do not always occur in the same way. For example, [symbol] is pronounced as /p-a-t-i-b-a-t-k-a:-n/ and [symbol] is pronounced as just one syllable, [symbol] In other words, the syllable [symbol] is omitted from pronunciation in this situation.

Final consonants are propagated to be a separate syllable: A problem arises in a polysyllabic word where the final consonant of the forthcoming syllable is explicitly pronounced with /a/ as an additional syllable. For example, in [symbol] which is pronounced as /kh-a-t-th-a-l-i:-j-a/, [symbol] corresponds to /kh-a-t-th-a/. In this instance, the letter [symbol] the final consonant of the syllable [symbol] is propagated to be an additional syllable, which is pronounced as /th-a/. However, the problem does not always happen in the same way. For instance, in [symbol] which is pronounced as /kh-a-t-s?-a-w/, the syllable [symbol] is pronounced as a standard syllable, and the additional syllable is not propagated.

Leading vowels and syllabification more complicated: A leading vowel is reverted back to the vowel of the second syllable in pronunciation. For example, “ [symbol] z,10 ” is usually pronounced as /k-e:/, where [symbol] has a /k/ sound and [symbol] has an /e:/ sound. However, in [symbol] which is pronounced as /k-a-s-e:-m/, [symbol] is inverted after two initial consonants [symbol] and [symbol] and is taken as the vowel of the second syllable, while [symbol] is pronounced as /k-a/ in the first syllable.

Consonants used as vowels: There are a number of consonants that can also be used as vowels. In particular, there are four such special vowels in Thai. [symbol] is pronounced as “r-i”, which means that the letter can be taken as a syllable directly, while a standard syllable is usually composed by an initial consonant, a vowel and an optional final consonant. [symbol] can also be combined with other consonants to construct syllables such as [symbol] etc. Because there are a limited number of combinations of [symbol] with other consonants, the special vowel can be processed relatively easily.

[symbol] itself is a common consonant. [symbol] is pronounced /r/ or /n/ when it is taken as an initial consonant or a final consonant, respectively. However, when two [symbol] s are placed after a consonant, it can be taken as a vowel. For example, in [symbol] the phoneme transcription is /th-a-m/, where [symbol] is pronounced “a”. At the same time, [symbol] can be placed without any final consonants and is pronounced as /a-n/, such as in [symbol] which is pronounced as /N-a:-m-s-a-n/.

[symbol] is a consonant which is pronounced as /w/ when either as an initial consonant or a final consonant. When it is placed between two consonants, it is taken as a vowel, sounding like ‘ua’. For example, [symbol] is pronounced as /kh-ua-t/.

[symbol] is a consonant which is pronounced as a glottal stop, e.g., /s?/. However, when it is placed directly after consonants, it can be taken as a vowel, pronounced as /O:/. For example, [symbol] beam is pronounced as /kh-O:-N/.

Various vowels' length for the same syllables in a different context: A problem occurs when a vowel is pronounced as a short/long vowel according to its grapheme but is pronounced as a long/short vowel instead. For example, the syllable [symbol] should be pronounced as /s-e:-n/. It is pronounced this way in [symbol] which is pronounced as /f-u:-s?-O:-r-e:-t-s-e:-n/. However, the syllable is pronounced as /s-e-n/ in [symbol] which is pronounced as /s-e-n-t-i-m-e:-t/.

Various pronunciations for final consonants: Thai syllables are composed of initial consonants, vowels, final consonants and tone marks. Final consonants are not the consistent parts of syllables. In the event that Thai words are wrongly syllabized, wrong phoneme transcription are obtained because one consonant may have different phonemes as an initial consonant or as a final consonant. For example, in the word [symbol] two [symbol] s make up the initial consonant of the first syllable and the final consonant of the second syllable, being pronounced as /b/ and /p/, respectively. In some syllables, the final consonant is not necessary, such as in [symbol] which is pronounced as /s-a:-s?-u-d-I-s?-a:-r-a-b-ia/. In this case, [symbol] is a complete syllable. Therefore, in Thai, initial consonants and final consonants should be differentiated before it is turned into a phoneme series. Final consonants may have irregular changes in the phonemes. For example, /t/ may be changed to /d/ for [symbol] /p/ to /b/ for [symbol] /t/ to /s/ for [symbol] /p/ to /f/ for [symbol] and /w/ to /l/ for [symbol] If a syllable is ended with a vowel, /s?/ may be appended to the phoneme. However, this case does not always occur in the same manner. For example, the syllable [symbol] may be pronounced as /k-O/ or /k-O-s?/in different contexts.

In one embodiment of the invention, syllabification is implemented sequentially as depicted in FIG. 3. Step 300 in FIG. 3 involves preprocessing. In preprocessing, leading vowels and some other non-standard syllabifications are processed. All of the irregular syllables, including all cases with leading vowels and syllables labeled with a silent mark, are listed in a table and are processed before syllabification.

At step 310, “obvious” syllabification is processed. Initial vowels always constitute the beginning of syllables. Thus syllabification can be easily processed in this instance. If initial vowels are followed by single-letter initial consonants, initial vowels are inverted after the initial consonants. If initial vowels are followed by double-letter initial consonants and can be combined with another letter to make up new vowels, then the initial vowels are inverted after the double-letter consonants.

In Thai, initial consonants include single-letter consonants and double-letter consonants. When vowels are detected, initial consonants should comprise the beginning of syllables. In such a situation, syllabification can be partially performed.

Additionally, there are some terminated vowels and some unterminated vowels in Thai. In the former case, terminated vowels are at the end of the syllables. In the latter case, the vowels must be followed by final consonants in order to complete the syllables.

It should be noted that tone marks can be combined with normal vowels to make up new vowels. Since there are four tone marks ( [symbol] , [symbol] , [symbol] , [symbol] ) and a special mark [symbol] , which makes long vowels to become short ones, the five marks can be combined with normal vowels to make up new vowels. For instance, the special vowel “ [symbol] ” can be combined to become normal unterminated vowels. [symbol] alone is a special vowel, which has lower priority than normal vowels. When it is taken as a vowel, it should be followed by a final consonant. Additionally, tone marks can be treated as normal vowels separately when there are no other vowels existing. Thus, when tone marks are not with vowels, syllabification can also be implemented since tone marks should follow initial consonants.

At step 320, the special vowel [symbol] is processed. Because the number of Thai syllables including [symbol] is limited, when words contain this vowel, they can be easily syllabified.

At step 330, the special vowel [symbol] is processed. When [symbol] is detected, it can be processed as a normal vowel.

At step 340, an obligatory split occurs. When the words still contain vowels, but syllabification is not completed, the segmentation is processed by determining whether final consonants should be appended according the preset rules.

At step 350, the special vowel [symbol] is processed. This vowel can be treated as an unterminated vowel. In other words, [symbol] must be followed by a final consonant if it is treated as a vowel. At step 360, the special vowel [symbol] is processed.

Step 370 involves the postprocess. When syllabification is not processed completely in the above steps, the postprocess step is implemented. A rule-based mechanism is used for this step.

After syllabification is finished, each syllable is converted to the corresponding phonemes at step 380. This can be accomplished using a rule based approach. This step is easy to implement because initial consonants, vowels and final consonants have been determined for all of the syllables. The final phonemes are then obtained at step 390 by concatenating the obtained phonemes directly.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of converting a word sequence into a corresponding phonetic transcription for the Thai language, comprising:
preprocessing the word sequence;
syllabifying obvious portions of the word sequence;
syllabifying the special vowel [symbol]
syllabifying the special vowel [symbol]
for any words that contain vowels but have not yet completed syllabification, appending final consonants to the words when necessary according to preset rules;
syllabifying the special vowel [symbol]
syllabifying the special vowel [symbol]
processing any words in the word sequence that have not yet completed syllabification; and
obtaining a final phoneme series by concatenating phonemes for all of the generated syllables.

2. The method of claim 1, wherein the special vowel [symbol] is processed by treating all instances of [symbol] in the word sequence as a normal vowel during syllabification.

3. The method of claim 1, wherein the special vowel [symbol] is treated as an unterminated vowel during syllabification.

4. The method of claim 1, wherein the syllabification of any words in the word sequence that have not yet been terminated involves the use of a rule-based approach.

5. The method of claim 1, wherein the obtaining of a final phoneme series involves the use of a rule-based approach to convert each syllable to a corresponding phoneme.

6. The method of claim 1, wherein the special vowel [symbol] is treated as a normal vowel during syllabification.

7. The method of claim 1, wherein the preprocessing includes listing in a table and processing all irregular syllables before syllabification.

8. The method of claim 1, wherein obvious syllabification includes:
designating all initial vowels in a word as the beginning of a syllable;
inverting all initial vowels if followed a single letter consonant;
inverting all initial vowels if followed by a double letter consonant and can be combined with another letter to form a new vowel; and
syllabifying all initial consonants that are followed by tone marks.

9. A computer program product for converting a word sequence into a corresponding phonetic transcription for the Thai language, comprising:
computer code for preprocessing the word sequence;
computer code for syllabifying obvious portions of the word sequence;
computer code for syllabifying the special vowel [symbol]
computer code for syllabifying the special vowel [symbol]
computer code for, for any words that contain vowels but have not yet completed syllabification, appending final consonants to the words when necessary according to preset rules;
computer code for syllabifying the special vowel [symbol]
computer code for syllabifying the special vowel [symbol]
computer code for processing any words in the word sequence that have not yet completed syllabification and
computer code for obtaining a final phoneme series by concatenating phonemes for all of the generated syllables.

10. The computer program product of claim 9, wherein the special vowel [symbol] is processed by treating all instances of [symbol] in the word sequence as a normal vowel.

11. The computer program product of claim 9, wherein the special vowel [symbol] is treated as an unterminated vowel during syllabification.

12. The computer program product of claim 9, wherein the syllabification of any words in the word sequence that have not yet been terminated involves the use of a rule-based approach during syllabification.

13. The computer program product of claim 9, wherein the obtaining of a final phenomena series involves the use of a rule-based approach to convert each syllable to a corresponding phoneme.

14. The computer program product of claim 9, wherein the preprocessing includes listing in a table and processing all irregular syllables before syllabification.

15. The computer program product of claim 9, wherein obvious syllabification includes:
designating all initial vowels in a word as the beginning of a syllable;
inverting all initial vowels if followed by a single letter consonant;
inverting all initial vowels if followed by a double letter consonant and can be combined with another letter to form a new vowel; and
syllabifying all initial consonants that are followed by tone marks.

16. An electronic device, comprising:
a processor; and
a memory unit operatively connected to the processor and including a computer program product for converting a word sequence into a corresponding phonetic transcription for the Thai language, including:
computer code for preprocessing the word sequence;
computer code for syllabifying obvious portions of the word sequence;
computer code for syllabifying the special vowel [symbol]
computer code for syllabifying the special vowel [symbol]
computer code for, for any words that contain vowels but have not yet completed syllabification, appending final consonants to the words when necessary according to preset rules;
computer code for syllabifying the special vowel [symbol]
computer code for syllabifying the special vowel [symbol]
computer code for processing any words in the word sequence that have not yet completed syllabification; and
computer code for obtaining a final phoneme series by concatenating phonemes for all of the generated syllables.

17. The electronic device of claim 16, wherein the special vowel [symbol] is treated as an unterminated vowel during syllabification.

18. The electronic device of claim 16, wherein the preprocessing includes listing in a table and processing all irregular syllables before syllabification.

19. The electronic device of claim 16, wherein obvious syllabification includes:
designating all initial vowels in a word as the beginning of a syllable;
inverting all initial vowels if followed a single letter consonant;
inverting all initial vowels if followed by a double letter consonant and can be combined with another letter to form a new vowel; and
syllabifying all initial consonants that are followed by tone marks.

20. A system for converting a word sequence into a corresponding phonetic transcription for the Thai language, comprising:
a processor; and
a memory unit operatively connected to the processor and including:
computer code for preprocessing the word sequence;
computer code for syllabifying obvious portions of the word sequence;
computer code for syllabifying the special vowel [symbol]
computer code for syllabifying the special vowel [symbol]
computer code for, for any words that contain vowels but have not yet completed syllabification, appending final consonants to the words when necessary according to preset rules;
computer code for syllabifying the special vowel [symbol]
computer code for syllabifying the special vowel [symbol]
computer code for processing any words in the word sequence that have not yet completed syllabification; and
computer code for obtaining a final phoneme series by concatenating phonemes for all of the generated syllables.
